(19) United States
(12) Patent Application Publication
(10) Pub. No.: US 2002/0174041 A1
(43) Pub. Date: Nov. 21, 2002

(54) System and method for monitoring and managing payments for educational content

(75) Inventors: William Grey, Millwood, NY (US); Clifford Alan Pickover, Yorktown Heights, NY (US); Paul Andrew Moskowitz, Yorktown Heights, NY (US); Stephen J. Boies, Mahopac, NY (US)

Correspondence Address: Duke W. Yee, Carstens, Yee and Cahoon, L.L.P., P.O. Box 802334, Dallas, TX, 75380, US

(73) Assignee: International Business Machines Corporation, Armonk, NY

(21) Appl. No.: 09/858,702

(22) Filed: May 16, 2001

(51) Int. Cl. G06F 17/60

(52) U.S. Cl. 705/32

(57) ABSTRACT

The present invention provides an improved system and method for managing the delivery and revenue associated with the access and delivery of educational content in a plural user operating environment such as a computer network. The invention provides a method and system which allows multiple users to access and pay for educational content in a variety of ways including in bulk, on a pay per view basis, or on a pay as you view basis. Likewise, the invention provides a method and system for reimbursing the author, owner, and supplier of the content accessed by the users as a variable function of student access to the content provided.

### BACKGROUND OF THE INVENTION

1. Technical Field

The present invention relates to content delivery over a large computer network, and more particularly to a system and method which provides monitoring and payment for the delivery of educational content to a plurality of student clients.

2. Description of Related Art

With the advent of digital technology, increasing numbers of paintings, pictures, books, songs, live performances, texts, diagrams, recordings, video clips, and educational courses utilizing them for instructional purposes and/or entertainment are becoming available in machine readable forms. In particular, many computer-assisted lessons, training materials, and other instructional courses include works which are being delivered to students all over the globe as the world wide web has broken down geographical access barriers to educational institutions. The “electronic classroom” is capable of delivering content which has become known in the popular vernacular as “distance learning”, “e-learning”, “computerized training”, “computer-assisted instruction”, “computer-aided learning”, “web-based training”, “intranet-based learning”, “web courses”, “virtual university”, “computerized curriculum delivery system”, “courseware delivery system”, “instructional management system”, “interactive education”, and similar phrases. These phrases are simple terms that refer to efforts to use computers to help educate students. As used here, “students” are not necessarily traditional students enrolled in high schools, colleges, universities, and the like, but are rather people who receive instruction through courseware. Courseware may be used by traditional students, but it may also be used by employees of government agencies and corporations, for instance. To better understand the present invention in the context of existing computer-assisted educational efforts, it will helpful to understand certain distinctions, as discussed below.

There are many different computer applications available to facilitate education by focusing on providing authoring tools and authoring environments. For instance, tools for authoring include tools for reformatting text into HTML format and adding hyperlinks; tools for integrating audio and/or video content with text content; and tools for creating interactive forms to obtain information from students and provide appropriate responses. In short, authoring tools help instructors create courseware content.

In contrast, delivery tools help deliver courseware to students. In the case of “web-based training”, “intranet-based learning”, and “web courses”, delivery tools typically include TCP/IP networks and web browsers. Computer workstations themselves may also be viewed as delivery tools, particularly when the courseware is written to be used on a stand-alone computer rather than being delivered over a network connection.

Many existing approaches to computer-aided teaching include both authoring and delivery components. However, the problems and solutions associated with authoring are not necessarily the same as those associated with delivery. The present invention is concerned primarily with delivery as opposed to authoring.

Likewise, many computer-based training systems do not require a network connection in order to function. All necessary courseware content is stored on a computer disk, CD-ROM, or other medium which is directly accessible to the computer being used by the student, making it unnecessary to send any content over a network connection. The tools and techniques for managing courseware content in such stand-alone systems are basically the same as the tools and techniques for managing application programs, operating systems, and other types of software installed on user workstations, namely written licenses, disk copy-protection schemes, license serial numbers, and the like.

Network-based training approaches either take advantage of a network connection if one is available, or else they require such a connection. Different network-based systems use the network in different ways. Sometimes courseware content is stored on a server and delivered over the network to users as needed. In some cases, part or all of the content is stored on the local network node but licensing is enforced through a server. For instance, the content stored locally might be encrypted, and the decryption key might be available only from the server and then only after the user is authenticated. Some network-based educational systems allow students to interact with one another and/or with the instructor through email or chat rooms. Some systems administer tests by having the student send test answers to a server, which grades the test and notifies the student of the results. Some systems provide instructors with access over the network to a database of administrative information such as student grades and a list of the students who have viewed a given lesson. Of course, many systems combine one or more of these features and some also use networks in other ways.

The present invention is concerned with network-based courseware delivery systems, as opposed to stand-alone courseware delivery systems.

With the advent of improved delivery hardware and software, networked courseware delivery systems may share content between multiple users synchronously or asynchronously. With synchronous sharing, users and/or instructors exchange information in a real-time or interactive way. Examples of synchronous sharing include telephone conversations, video conferencing, and chat rooms. In contrast, asynchronous sharing involves an exchange of information in which the participants expect delays, or that involve a one-way flow of information rather than an exchange. Examples of asynchronous sharing include downloading a previously created multimedia presentation and Usenet postings. Email does not fit neatly in either category, because it can be either synchronous or asynchronous in practice. Some aspects of the present invention are concerned with asynchronous sharing, and in particular with asynchronous delivery of previously created courseware content. However, other aspects of the invention are concerned with synchronous information exchanges, such as real time video lectures.

As noted, some courseware is presented to students who attend traditional institutions of higher education. In many cases, those students pay for their use of courseware by paying tuition to the institution. If the institution is not the owner of the courseware, the institution then makes separate arrangements for payment to the owner. Likewise, students who are employees of a government agency or corporation generally receive access to courseware through their employer without personally making arrangements to pay the courseware owner directly. In either case, at the time a student sits down to actually use the courseware it may be necessary to authenticate the student to the system but it is not necessary for the student to provide a credit card number or similar payment mechanism. For convenience, courseware management systems which do not require direct payment from students are referred to herein as “academic systems”. In “commercial systems” some provision must be made for funds transfer before a student is given full access to courseware content (although a demo might be available at no charge). For instance, each student may be required to provide a credit card number, to pre-pay for access by giving cash or a check to an attendant, or to provide individual billing information if credit is being extended. The present invention may be configured to provide various billing and payment methods, including but not limited to, both academic and commercial payment systems.

Traditionally, educational content has been delivered and paid for in a comparatively static fashion. Students enroll in a course at a university and pay a fixed amount in tuition, perhaps based on the number of educational credits. The university in turn would pay faculty either a fixed annual salary (in the case of full time professors), or a fixed fee for teaching the course (in the case of adjunct faculty). Students would purchase text books and generally pay a fixed fee for the course materials.

As educational content is delivered electronically, this static approach will change. Educational providers may still charge a fixed fee for courses, but their payments to suppliers of content will no longer be fixed. For example, multiple universities may collaborate in delivering content under a single umbrella. Rich media, owned by different content providers, may be incorporated into courses. Professors will no longer receive fixed payments, but may instead be compensated based on how frequently their material is referenced in an interactive course or on a price per capita viewer basis. Additional features and advantages of the present invention will become more fully apparent through the following description.

### SUMMARY OF THE INVENTION

The present invention provides an improved system and method for managing the delivery and revenue associated with the access and delivery of educational content in a plural user operating environment such as a computer network. In particular, the invention provides a method and system which allows multiple users to access and pay for educational content in a variety of ways including in bulk, on a pay per view basis, or on a pay as you view basis. Likewise, the invention provides a method and system for reimbursing the author, owner, and supplier of the content accessed by the users.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2A is a table illustrating different content source fees by which a content provider is paid for access to educational content;

FIG. 2B is a table illustrating various content sources which author or create educational content for student clients;

FIG. 2C is a table illustrating various methods of charging fees associated with the provision of educational content to a student client;

FIG. 2D is a table illustrating various payment disbursement deadlines whereby a content source receives payment for the content provided to a student client, or for the fees associated with the provision of educational content to a student client;

FIG. 2E is a matrix representing a content fee schedule by which a student client or service provider determines the amount and time of payment for content provided for student client access by a content provider;

FIG. 2F is a matrix representing a course fee schedule by which a student client enrolling in a course is presented with content access options and the fees associated with access to particular content;

FIG. 2G is a matrix representing a student enrollment and fee schedule where the student client or service provider may select the fee type and quantity of content provided to the student client;

FIG. 3A depicts a block diagram of the preferred embodiment of the invention herein disclosed comprising a content server and service provider which provide registration, billing and network delivery of content accessed by student clients;

FIG. 3B depicts a block diagram representing an alternative embodiment of the present invention whereby the functions of the service provider are centralized within the content server and provided directly to the student client from the content server;

FIG. 3C depicts a block diagram representing another alternative embodiment of the present invention comprising a service provider which provides registration, billing and network delivery of content accessed by student clients, and a content server which provides educational content from one or more content sources;

FIG. 4 is a flow chart representation of one embodiment of the present invention as viewed from the third party service provider perspective;

FIG. 5 is a flow chart representation of one embodiment of the present invention as viewed from the student client perspective;

FIG. 6 is flowchart depicting the interaction of the content server, service provider and student client in a typical transaction by which the present invention can be implemented; and,

FIG. 7 is a flowchart illustrating an alternative interaction between the content server, service provider and student client by which the present invention may be implemented.

### DETAILED DESCRIPTION OF THE PREFERRED EMBODIMENT

With reference now to the figures, and in particular with reference to FIG. 1, a pictorial representation of a distributed data processing system in which the present invention may be implemented is depicted. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

In the depicted example, a service provider 104 is connected to network 102 along with a content server 106. In addition, clients 108 and 110 also are connected to network 102. These clients 108 and 110 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network. In the depicted example, content server 106 provides data, such as boot files, operating system images, and applications to student clients either directly via network 102 or via service provider 104 which is also connected to network 102. It should be noted that the data stored on the content server is derived from various “content sources” or “content providers” which are the actual authors, creators and/or owners of the actual data content. It should be further noted that in some embodiments there may be multiple content servers, each with data derived from at least one of various “content sources” or “content providers” which are the actual authors, creators and/or owners of the actual data content.

The service provider 104 includes at least one registration server. It is sufficient to note that the service provider 104 includes a registration manager and a registration database for new user registration, and that each registration server is typically free of courseware or other deliverable content that is managed by the distributed data network 100. In the preferred embodiment, content or courseware is not stored on the service provider 104 server. It should be noted that service provider may be an academic institution or a third party content provider which interfaces with academic institutions, corporations or other sources of educational content and training materials.

The content server 106 may include one or more servers and databases. Each content server 106 is linked by network 102 for network communications with the service provider 104 registration server. In an embodiment containing a single service provider 104, such as the embodiment illustrated, each content server 106 has a connection through network 102 (or may readily obtain such a connection) to service provider 104 and its registration server. In embodiments containing more than one service provider 104, different content servers 106 may communicate over one or more network 102 links with one or more service providers 104. Each network link may involve a dedicated link, a virtual circuit, a tunnel through one or more intervening networks, or one or more other types of network communication links known to those of skill in the art.

The content server 106 contains courseware and/or other educational content managed by the architecture. Each content server 106 serves the educational content for presentation to registered student clients, that is, users who have previously registered with the service provider 104. At a minimum, registration provides student clients with a unique user name or user ID; it may also coordinate a password or otherwise manage access control to the content. With the possible exception of registration for free demonstrations, which may be available in some embodiments, registration also obtains billing or payment information such as the user's credit card information, purchase order, and/or sponsor identity.

The service provider 104 and the content server 106 may be implemented with a combination of computer hardware (e.g., disk or other non-volatile storage, RAM or other volatile storage, one or more processors, network interface cards, supporting I/O equipment) and computer software (e.g., operating system software, networking software, web browser software, and inventive software as described herein). In particular, suitable software for implementing the invention is readily provided by those of skill in the art using the teachings presented here and programming languages and tools such as Java, Pascal, C++, C, CGI, Perl, SQL, APIs, SDKs, assembly, firmware, microcode, and/or other languages and tools.

The student clients 108 and 110 include at least one client workstation and typically include multiple workstations. Each student client 108 and 110 is connectable to a content server 106 by a link to network 102. At some point, each student client workstation is able to present, to at least one registered user, courseware and/or other content which is served over network 102 by the content server 106. The content may be conventional content, or it may be modified by treating critical portions as described herein, or it may be a combination of untreated and treated works. Although student clients 108 and 110 may constitute workstations in deference to the expected typical situation, it is clear that laptops, wireless telephones, personal digital devices (“PDA's”) and other computers and devices may also serve as student clients 108 and 110.

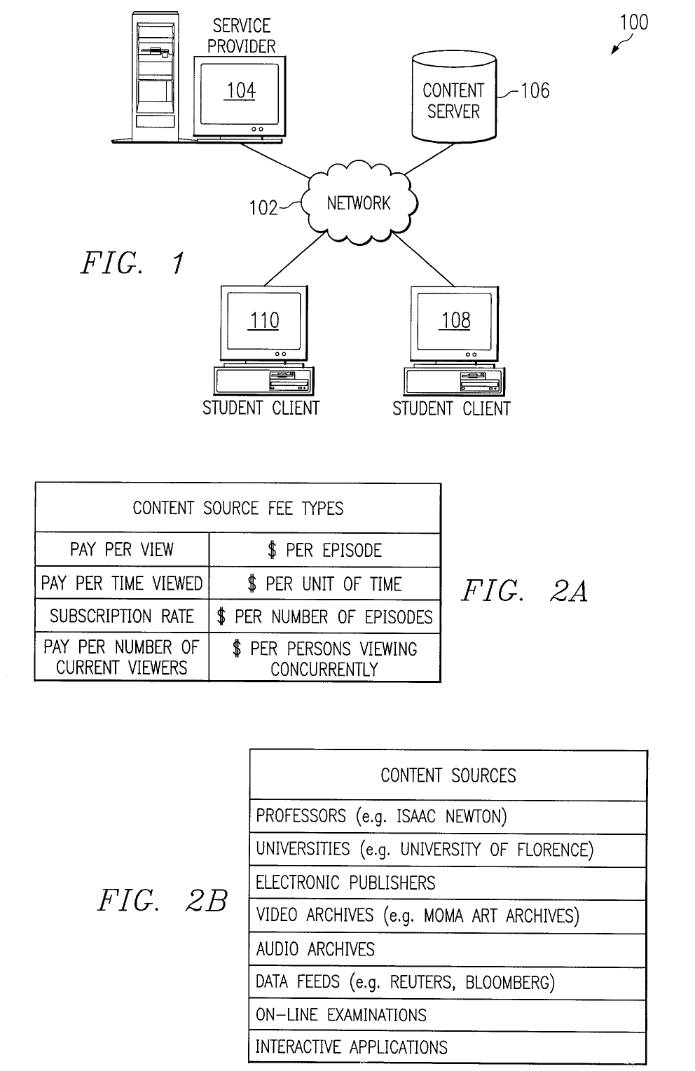

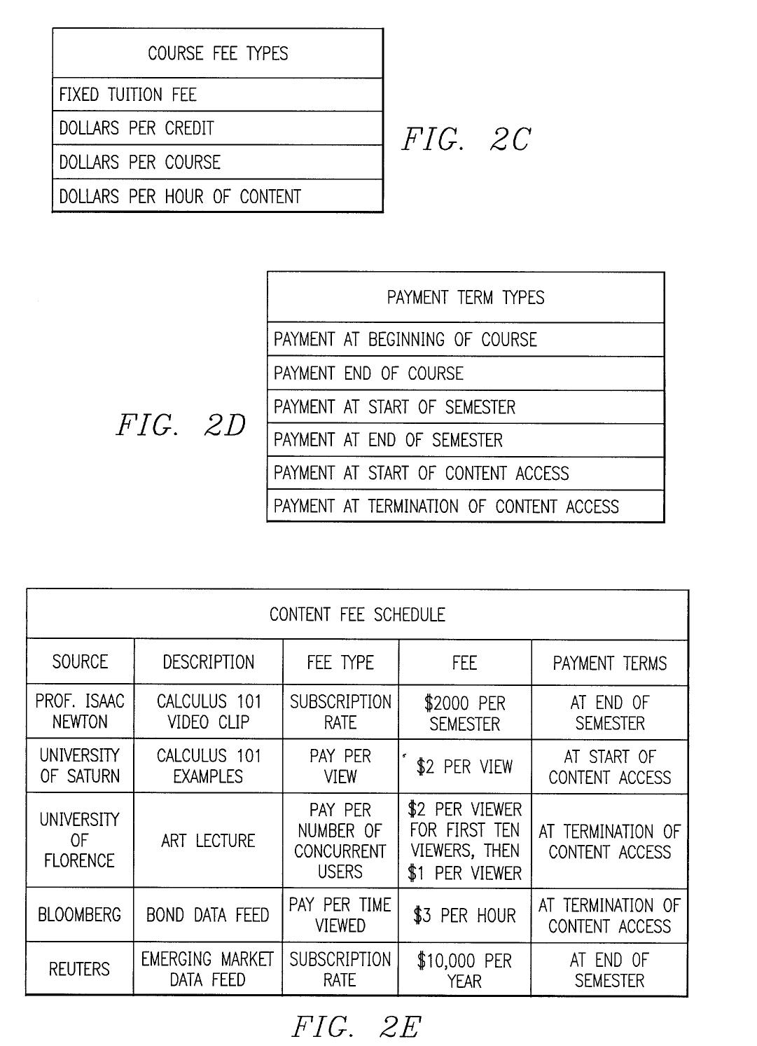

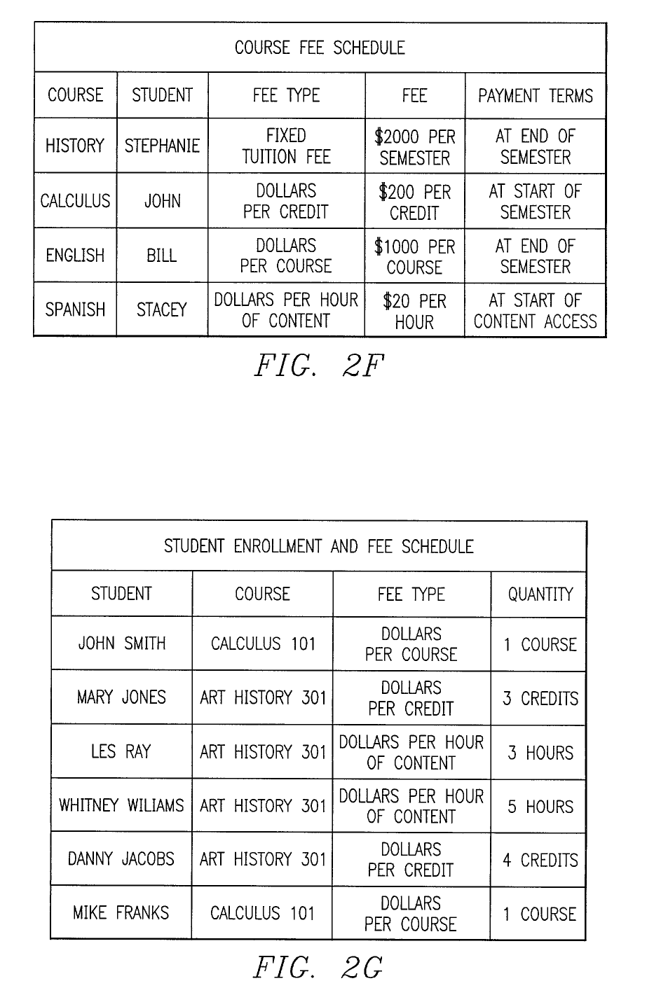

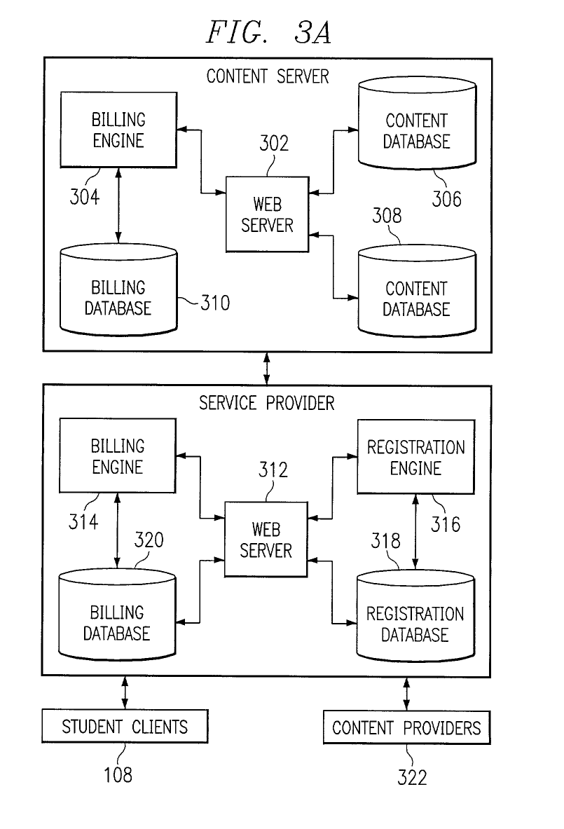

FIGS. 2A and 2B represent block diagrams of content source fee types and content sources that assist in the selection and calculation of content sources and fees associated therewith. The content source fee types are payment options presented to the student clients 108 and 110 or preselected by the service provider 104 or academic institution by which the content accessed by the student clients 108 and 110 is priced. Examples include delivery of content on a pay per view period, pay on the amount of time spent viewing the content, and payment on a subscription rate. Alternatively, content may be priced according to the number of student clients 108 and 110 accessing the content or viewing the content concurrently. Likewise, the course fees paid to the actual author or source of the content could be paid on a dollars per course credit, dollars per course, and dollars per hour of content utilized. FIG. 2B represents the sources which may be available to student clients 108 and 110 that are stored or provided through content server 106. For instance, academic universities and professors may record lectures or entire semesters of coursework on video or audio data storage means which are then transferred to content server 106 for access via network 102 by student clients 108 and 110. For instance, video and audio archives of significant historical events, such as Desert Storm or John F. Kennedy's inaugural speech, may be accessed by student clients 108 and 110 along with other data feeds and interactive applications. Likewise, professors or instructors could provide examinations online, whereby student clients 108 and 110 could take course exams on a predetermined schedule, after completing designated course material, or when they at their discretion feel that have achieved sufficient mastery of the course material.

FIGS. 2C and 2D represent methods of determining payment for the content supplied by different sources to the service provider 104 and/or content server 106. Naturally, the course fees could be determined in a variety of ways including by preset or negotiated tuition fees.

Once a course fee type is selected, alternative methods of timing the disbursement of payments to the content provider(s) and payments by the students may then be chosen from the schedule in FIG. 2D. For example, the payment terms to the content provider(s) (e.g. author, source or owner of the content) may provide for payment at the beginning or end of the course, or at the beginning or end of an academic semester. Alternatively, payments may be made at the time the content is actually accessed by the student client 108 or at the termination of such access. The table shown in FIG. 2D illustrates some of the more common payment options; however, the method provides a vast array of payment options which can be implemented between the service provider 104 and the source of the actual content, or between the student and the service provider.

FIGS. 2E, 2F and 2G consist of a content fee schedule, a course fee schedule and a student enrollment and fee schedule, respectively. FIG. 2E shows typical examples of how the actual sources of the content provided to student clients 108 and 110 are reimbursed. For example, the source of the content is a history professor. The student clients 108 and 110 will be charged for the professor's content (i.e. lectures) on a pay per view basis. The actual fee charged by the professor is a fixed tuition fee of $500.00 which is payable to the professor at the beginning of the course. Therefore, the service provider 104 is required to pay the professor $500.00 at the beginning of the course, while the student clients 108 and 110 access to the professor's history lectures via network 102 will be billed on a pay per view basis. FIG. 2F represents the fee schedule arrangement whereby the student clients 108 and 110 are charged for the provision of selected content. For example, student client 108 Stephanie enrolls in a history course that is priced on a fixed tuition fee basis of $2000 per semester. In another example, student client Stacey enrolls in a Spanish course priced on a dollars per hour of content basis of $20 per hour. This allows student client 108 Stacey greater flexibility to arrange at what dates and times he or she access the history content. FIG. 2G represents a matrix of student clients 108 and 110, many of whom are enrolled in the same courses, yet each student client 108 and 110 may pay for the course content on a different fee schedule. For example, student clients Mary Jones, Les Ray, Whitney Williams and Danny Jacobs are all enrolled in a course entitled Art History 301. However, each student client may pay a different fee type for the same course (e.g. fee based on dollars per course, dollars per hour of content accessed, dollars per credit, etc.) and may select the quantity of hours or credits needed to satisfy curriculum or training requirements.

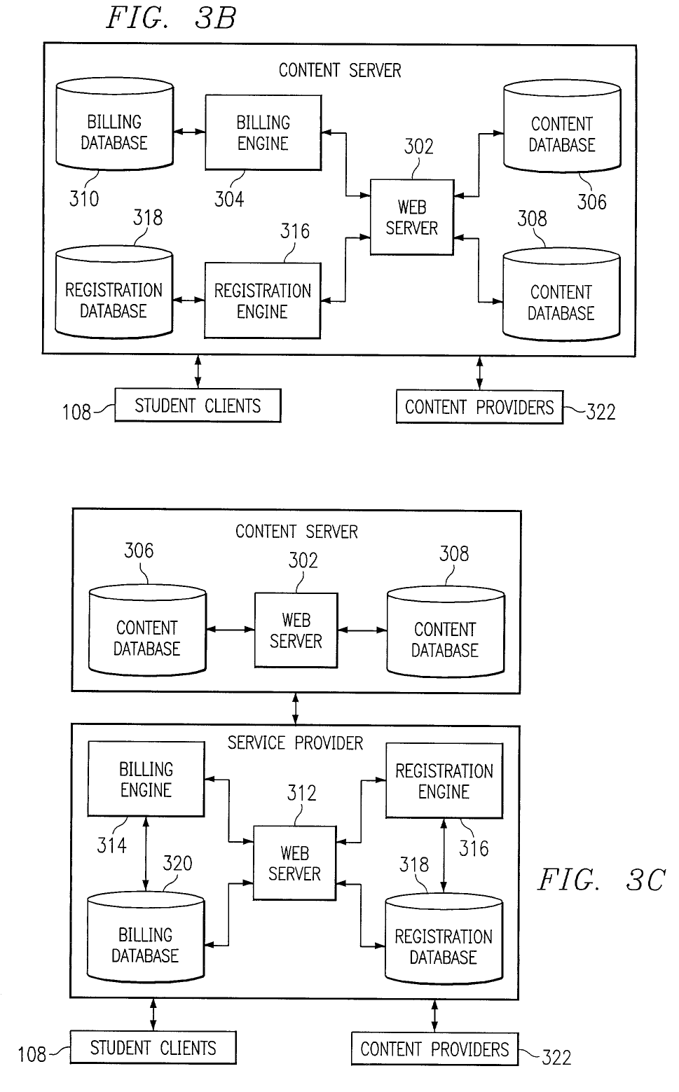

Turning to FIG. 3A, a block diagram depicting one embodiment of the present invention is shown whereby the content server 106 and service provider 104 architecture is presented in greater detail. The content server 106 is shown integrated with web server 302, billing engine 304, content databases 306 and 308, and billing database 310. Likewise, the service provider 104 is shown integrated with a server level system composed of web server 312, billing engine 314, registration engine 316, registration database 318 and billing database 320.

FIG. 3A further illustrates a registration engine 316 and registration database 318 which are integrated into the service provider 104. Collectively, the registration engine 316 and the registration database 318 form a registration module which provides unique user IDs and user password support for student clients 108 and 110. The registration module may also obtain and store in the registration database 318 information such as the identity of a corporate or government sponsor that employs the student client 108, and the student client's 108 email address for use in notifications of upcoming services or events. The proposed user ID and password are checked against existing registration information in the database 318 to make certain they are unique throughout the architecture embodiment. This provides security to student clients 108 so that charges for access content will be valid and services cannot be stolen by an unknown or duplicate student client 108 and then charged to the wrong student client 108. Of course, student clients 108 and 110 must still be careful to keep their own password information confidential and to choose passwords which are not simply a copy of their username or other easily guessed information. Student client login and authentication tools and techniques familiar to those of skill in the art may be used.

The content server billing engine 304 and billing database 310 interact with web server 302 for the transmission and receipt of billing data from the content provided by the content server 106 to the service provider 104. Content databases 306 and 308 supply content requested from the service provider 104 via web server 312. Billing engine 304 contains applicable content fee schedules as shown in FIGS. 2C, 2D and 2E with appropriate programming protocols to implement said schedules. As content is requested from student clients 108 and 110 via web server 312 connected to network 102, content is retrieved from content databases 306 and 308 whereby billing engine 304 calculates and provides the appropriate fee and payment options available to the service provider 104 for reimbursement of the content providers 322. It should be noted that before content is requested and delivered, the student client 108 has previously signed on to his/her account and entered the required password and payment information stored on registration database 318 to begin the session. As the requested content is transmitted from the content server 106 to the service provider 104 via network 102, billing engine 312 monitors the content accessed by the student client 108. Student client's 108 access is recorded on billing database 320. The schedules set forth in FIGS. 2F and 2G are contained and implemented within billing engine 320 which is programmed with the appropriate protocols to implement said schedules.

FIG. 3B represents an alternative embodiment of the architecture shown in FIG. 3A which merely centralizes the functions of service provider 104 into the content server 106 which is set forth in the foregoing discussion.

FIG. 3C represents an alternative embodiment of the architecture shown in FIG. 3A which merely centralizes the billing functions of the content server 106 into service provider 104 which is set forth in the foregoing discussion. Although for clarity of exposition FIG. 3C shows only a single content server, in practice there could be multiple content servers.

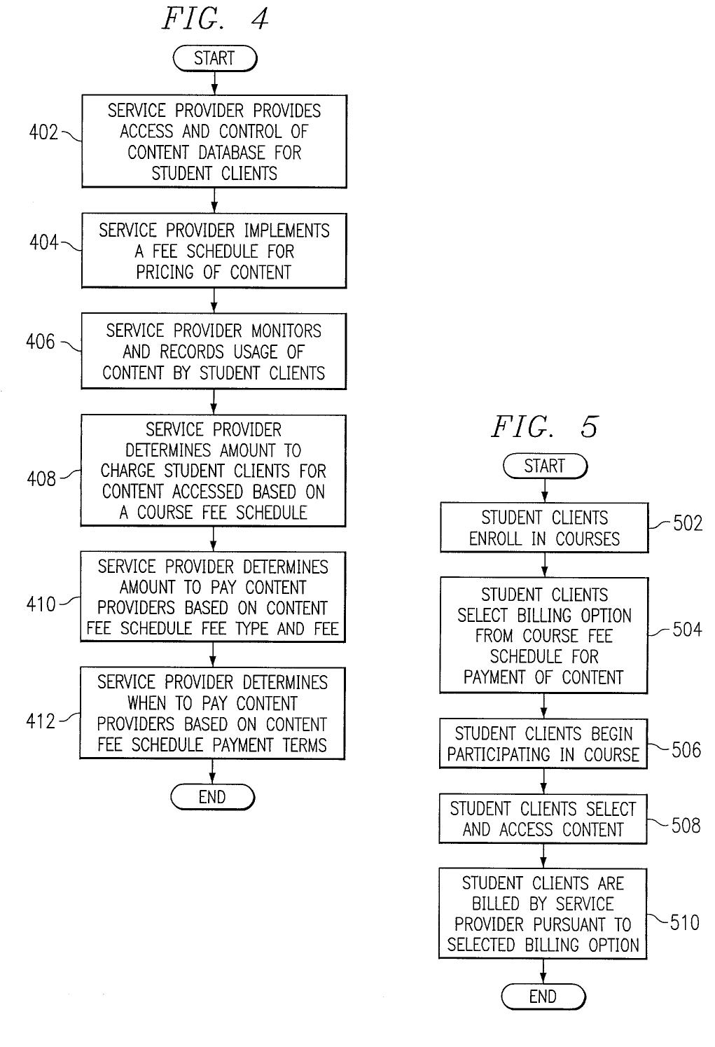

FIG. 4 depicts the preferred embodiment of the present invention outlining a method by which educational content is requested by student clients 108 and 110 and provided by a third party service provider 104. In this scenario, a service provider 104 serves as a conduit for monitoring and recording usage of content by student clients 108 and 110, then manages the collection of access fees from the student clients 108 and 110 along with calculating and disbursing appropriate payments to content providers 322 for the student clients' 108 and 110 usage of content. Initially, the service provider provides student clients with access to the content server (Step 402). Next, the service provider implements the appropriate fee schedule for the pricing of content to student clients (Step 404). The service provider monitors and records the content usage of the student client (Step 406) and then determines the amount to charge the student client for accessed content by generating calculations based on the appropriate course fee schedule (Step 408). The service provider next determines the appropriate amount to pay content providers based on the content fee schedule (Step 410). The service provider then determines when to pay the content provider based on the indicated content fee schedule payment terms (Step 412).

With reference to FIG. 5, the system and method of the present invention depicting the student clients' interaction with the content server and service provider is depicted. Initially, student clients register with the service provider and enroll in appropriate courses (Step 502). Next, student clients select their preferred billing option from the course fee schedule in payment of the content they desire to access (Step 504). The student clients participate in the selected course(s) by attending actual classroom sessions (Step 506) and/or by selecting and accessing content (Step 508). The student clients are then billed by the service provider pursuant to the billing option selected from the course fee schedule (Step 510).

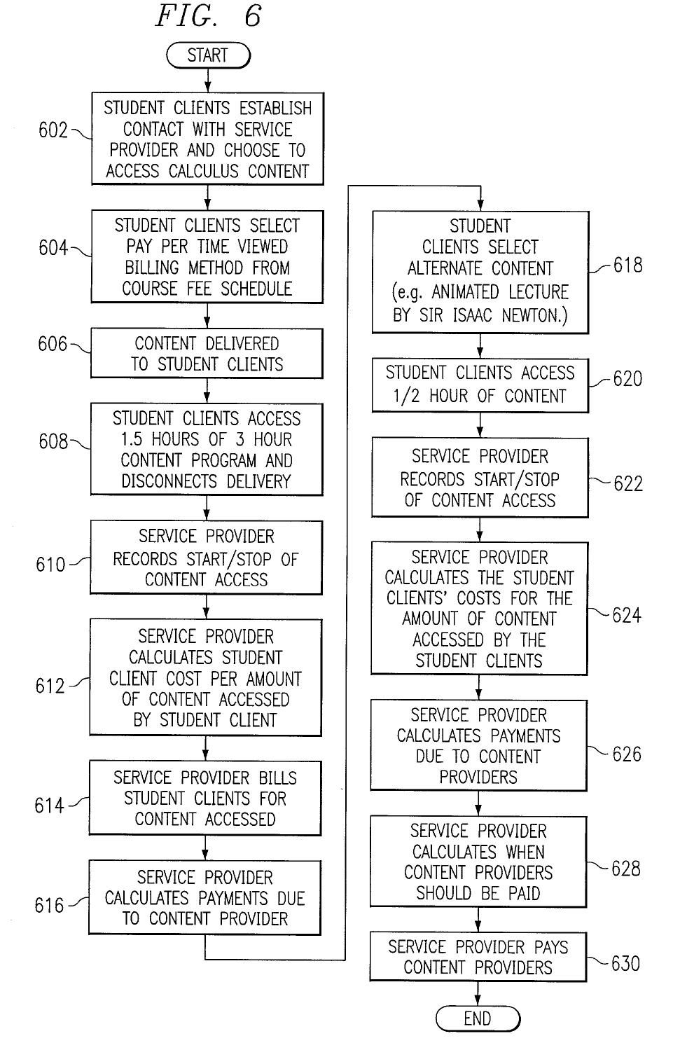

FIG. 6 represents a more detailed flow diagram showing an alternative embodiment of the present invention. For illustrative purposes, the flow diagram describes an interaction with a single student client. However, in practice, multiple student clients could be monitored simultaneously. The student client establishes contact, register and choose appropriate content (Step 602). In this example, calculus content is selected. The student client selects the pay per time viewed billing method from the course fee schedule (Step 604). The calculus content is delivered to the student client via the web server connection network between the content server and service provider server (Step 606). The student client accesses 1.5 hours of the 3 hour long content lecture (Step 608). The service provider server records the times and duration of the student client's content access (Step 610). Next, the service provider calculates the cost to the student client for the amount of content accessed by the student client (Step 612). The service provider bills the student client for the amount of content accessed pursuant to the appropriate course fee schedule (Step 614) and calculates the payment amount due to the content provider pursuant to the appropriate content fee schedule (Step 616). Now, the student client decides to select and view alternate content pertaining to an animated lecture by Sir Isaac Newton (Step 618). Once more, the student client accesses the new content for one half hour (Step 620) and the service provider server records the start/stop access times and duration of the student client's access (Step 622). The service provider calculates the student client's costs for the content accessed client based on the amount of content accessed by the student client pursuant to the appropriate course fee schedule (Step 624). Then the service provider calculates the payments due to the content providers (Step 626) as well as when the payments to the content providers should be made according to the content fee schedule (Step 628). At the designated time, the service provider pays the service providers for the content (Step 630).

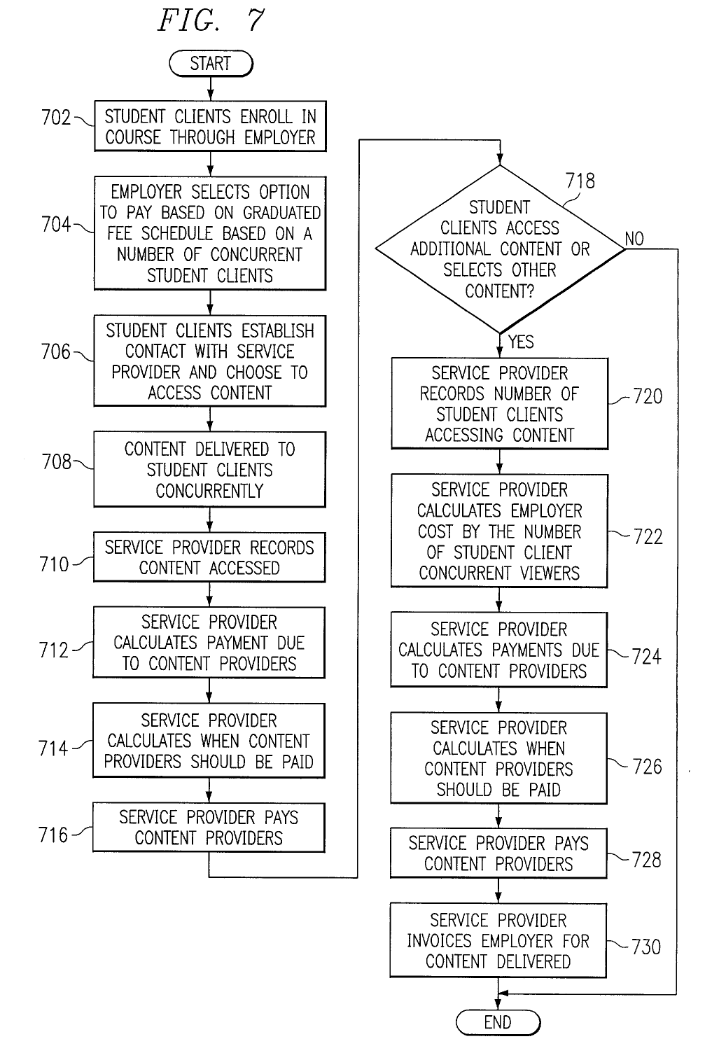

FIG. 7 represents another alternative embodiment of the present system and method wherein a student client enrolls in training administered by his or her employer. Initially, the student client registers and enrolls in a particular training course through his employer via a network connection to a service provider (Step 702). In this embodiment, the employer selects the content source payment option from a content source fee option that is based on a graduated fee schedule that calculates payments based on the number of concurrent student clients which will access the content (Step 704). Student clients establish contact via a network with the service provider and choose to access the appropriate content (Step 706). The content is delivered from the content server via the service provider to all student clients accessing the content concurrently (Step 708). The service provider concurrently monitors and records the amount of content accessed by each student client (Step 710). Next, the service provider calculates the payments due to the content provider(s) (Step 712) and when the payments should be disbursed to the content providers (Step 714). These calculations are based on the referenced content source fee option chosen by the employer in Step 704. At the calculated time, the service provider disburses payment to the content provider(s) for content accessed by the student clients (Step 716).

The student clients may then be presented with a choice of accessing additional content or terminating the session (Step 718). If the student client declines to access additional or other types of content, the online session is terminated. If the student client chooses to access additional or new content, the service provider monitors and records the number of student clients accessing the content (Step 720). The service provider calculates the cost to the employer for the content provided to the student client(s) by utilizing a course fee schedule where the cost of the accessed content is a function of the number of concurrent student clients which accessed the content (Step 722). The service provider then calculates the payment(s) due to the content provider(s) for the content provided per the selected content fee schedule (Step 724) and when the payment(s) should be disbursed to the content provider(s) (Step 726). The service provider then disburses payment(s) to the content provider(s) (Step 728) and invoices the employer for the content delivered to the student client(s) (Step 730).

Of course, a multitude of different alternative embodiments of the inventive system and method disclosed herein could be constructed and exhaustively listed. Student client payment schemes will also be more dynamic, perhaps varying depending on the educational resources they consume. For instance, there could be fixed prices for courses, or their might be payments for services with price caps. Tiered pricing schemes might also be used, such as unlimited content for a fixed fee for students who consume large amounts of content to learn effectively, or variable pricing for students who can learn effectively from CLIFF NOTES, and other literary resource publications. Some students could receive subsidized educational materials in exchange for viewing advertisements, or providing information to vendors. Prices could also vary depending on the content provider. For example, a student client might choose from a menu of professors when taking a course; the professor from an elite private university might command a significant price premium to the professor from a small local college.

Payments due to the content providers may be determined as functions based on different economic variables. For example, payments to content providers may be aggregated across multiple students. If educational content is being delivered to employees of a business, the firm may contract with a university or set of universities to deliver that content. In this case, the payments may be made for all of the employees of the business as a group, rather than for individual students. Convenience and efficiency are provided by optional content downloading options and utilization preferences as indicated by the user. Alternatively, suppose that payment monitoring is being performed by a service bureau, and its clients include content sources identified as University A and University B. University A hosts a course and uses content provided by University B. Conversely, University B hosts a course and uses content provided by University A. As a result University A owes University B $10,000 and University B owes University A $5,000. Rather than making two separate payments of $10,000 and $5,000, the payments are “netted”, and University A pays University B the net difference of $5,000, which represents the amount University A owes after deducting the amount University A is owed by University B.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for monitoring and managing payments for educational content comprising:
applying a fee schedule for pricing educational content;
recording the usage of educational content by one or more student clients; and,
determining appropriate payments to a plurality of content sources for usage of the educational content.

2. The method of claim 1 further comprising:
monitoring the usage of educational content by one or more student clients.

3. The method of claim 1 further comprising:
collecting said educational content from the plurality of plurality of content sources.

4. The method of claim 1 wherein said content source comprises at least one of an audio clip of a course lecture; a video image of course subject matter; electronic text of course subject matter; an image of books, journal articles, or other printed media; photographs, artwork, or other visual media; material originating from a professor, teacher, educational institution, or a publisher; an on-line examination; material constituting interactive applications; or material constituting a data feed, a photo archive, an audio archive or a video archive.

5. The method of claim 1 wherein said fee schedule comprises at least one payment option comprising payment per view, payment per time viewed, subscription rate, payment per number of concurrent viewers, payment per educational effectiveness, tiered pricing with volume discounts, tiered pricing with a premium paid for determined volume of usage, payment for total viewing with a cap, or a fixed percentage of total revenue.

6. The method of claim 1 wherein said fee schedule comprises fee structures that vary as a function of time; fees that vary as a function of system usage; fees that vary as a function of the geographic location of a student client; fees that vary as a function of access bandwidth; fees that vary as a function of delivery medium; fees that vary as a function of a student client's affiliation with an academic institution or other entity; or fees that vary as a function of the course in which a student client is enrolled.

7. The method of claim 2 wherein said monitoring records in a database each student client's usage of each form of content and the amount of time that the student has used the content.

8. The method of claim 2 wherein said monitoring records whether the student client was viewing multiple sources of content simultaneously.

9. The method of claim 2 wherein said monitoring is performed on a fee basis by a service provider.

10. The method of claim 1 wherein said appropriate payments are determined as a function of the recorded usage for each content source and determining the payment due based directly on a designated fee schedule.

11. The method of claim 1 wherein said appropriate payments are determined as a function of the recorded usage for each content source and the content source's designated fee schedule.

12. The method of claim 1 wherein said appropriate payments are determined as a function of the recorded usage for each content source based on determining the content source's relative contribution and fee schedule then allocating a fraction of total course revenue to each content source based on the content source's relative contribution.

13. The method of claim 1 wherein said appropriate payments are aggregated across the student client and content source.

14. The method of claim 1 wherein said appropriate payments are determined as a function of financial aid and content source utilization by the student client.

15. The method of claim 1 wherein said appropriate payments are determined as a function of scholarships or stipends and content source utilization by the student client.

16. The method of claim 1 wherein said appropriate payments are determined as a function of the net difference between payments to at least one content source.

17. The method of claim 1 wherein the educational content is provided over a communications network.

18. The method of claim 17 wherein said communications network comprises permanent connections, such as wire or fiber optic cables; temporary connections made through telephone connections; public and/or private wide area networks; local area networks; wireless networks, Bluetooth link, data communication networks or connections, intranets, internets, the Internet, routers, satellite links, microwave links, cellular or telephone networks, radio links, fiber optic transmission lines, ISDN lines, T1 lines, and DSL.

19. The method of claim 17 wherein the communications network includes at least one wireless link.

20. The method of claim 17 wherein the communications network includes at least one Bluetooth link.

21. The method of claim 1 wherein said recording the usage of educational content is performed on a fee basis by a service provider.

22. The method of claim 1 wherein said fee schedule is generated by a service provider.

23. A computer program product for monitoring and managing payments for educational content comprising:
first instructions for applying a fee schedule for pricing educational content;
second instructions for recording the usage of educational content by one or more student clients; and
third instructions for determining appropriate payments to a plurality of content sources for usage of the educational content.

24. The computer program product of claim 23 further comprising fourth instructions for monitoring the usage of educational content by one or more student clients.

25. The computer program product of claim 23 further comprising fifth instructions for collecting said educational content from the plurality of content sources.

26. The computer program product of claim 23 wherein said content source comprises at least one of an audio clip of a course lecture; a video image of course subject matter; electronic text of course subject matter; an image of books, journal articles, or other printed media; photographs, artwork, or other visual media; material originating from a professor, teacher, educational institution, or a publisher; an on-line examination; material constituting interactive applications; or material constituting a data feed, a photo archive, an audio archive or a video archive.

27. The computer product program of claim 23 wherein said fee schedule comprises at least one payment option comprising payment per view, payment per time viewed, subscription rate, payment per number of concurrent viewers, payment per educational effectiveness, tiered pricing with volume discounts, tiered pricing with a premium paid for determined volume of usage, payment for total viewing with a cap, or a fixed percentage of total revenue.

28. The computer product program of claim 23 wherein said fee structures that vary as a function of time; fees that vary as a function of system usage; fees that vary as a function of the geographic location of a student client; fees that vary as a function of access bandwidth; fees that vary as a function of delivery medium; fees that vary as a function of a student client's affiliation with an academic institution or other entity; or fees that vary as a function of the course in which a student client is enrolled.

29. The computer product program of claim 24 wherein said monitoring is performed by a database that monitors and records each student client's usage of each form of content and the amount of time that the student has used the content.

30. The computer product program of claim 24 wherein said monitoring records whether the student client was viewing multiple sources of content simultaneously.

31. The computer program product of claim 24 wherein said monitoring is performed on a fee basis by a service provider.

32. The computer product program of claim 23 wherein said appropriate payments are determined as a function of the recorded usage for each content source and determining the payment due based directly on a designated fee schedule.

33. The computer program product of claim 23 wherein said appropriate payments are determined as a function of the recorded usage for each content source and the content source's designated fee schedule.

34. The computer product program of claim 23 wherein said appropriate payments are determined as a function of the recorded usage for each content source based on determining the content source's relative contribution and fee schedule then allocating a fraction of total course revenue to each content source based on the content source's relative contribution.

35. The computer product program of claim 23 wherein said appropriate payments are aggregated across the student client and content source.

36. The computer product program of claim 23 wherein said appropriate payments are determined as a function of financial aid and content source utilization by the student client.

37. The computer product program of claim 23 wherein said appropriate payments are determined as a function of scholarships or stipends and content source utilization by the student client.

38. The computer product program of claim 23 wherein said appropriate payments are determined as a function of the net difference between payments to at least one content source.

39. The computer product program of claim 23 wherein the educational content is provided over a communications network.

40. The computer product program of claim 39 wherein said communications network comprises permanent connections, such as wire or fiber optic cables; temporary connections made through telephone connections; public and/or private wide area networks; local area networks; wireless networks, Bluetooth link, data communication networks or connections, intranets, internets, the Internet, routers, satellite links, microwave links, cellular or telephone networks, radio links, fiber optic transmission lines, ISDN lines, T1 lines, and DSL.

41. The computer product program of claim 39 wherein the communications network includes at least one wireless link.

42. The computer product program of claim 39 wherein the communications network includes at least one Bluetooth link.

43. The computer product program of claim 23 wherein said recording the usage of educational content is performed on a fee basis by a service provider.

44. The computer product program of claim 23 wherein said fee schedule is generated by a service provider.

45. A system for monitoring and managing payments for educational content comprising:
means for applying a fee schedule for pricing educational content;
means for recording the usage of educational content by one or more student clients; and,
means for determining appropriate payments to a plurality of content sources for usage of the educational content.

46. The system of claim 45 further comprising:
means for monitoring the usage of educational content by one or more student clients.

47. The system claim 45 further comprising:
means for collecting said educational content from the plurality of content sources.

48. The system of claim 45 wherein said content source comprises at least one of an audio clip of a course lecture; a video image of course subject matter; electronic text of course subject matter; an image of books, journal articles, or other printed media; photographs, artwork, or other visual media; material originating from a professor, teacher, educational institution, or a publisher; an on-line examination; material constituting interactive applications; or material constituting a data feed, a photo archive, an audio archive or a video archive.

49. The system of claim 45 wherein said fee schedule comprises at least one payment option including, payment per view, payment per time viewed, subscription rate, payment per number of concurrent viewers, payment per educational effectiveness, tiered pricing with volume discounts, tiered pricing with a premium paid for determined volume of usage, payment for total viewing with a cap, or a fixed percentage of total revenue.

50. The system of claim 45 wherein said fee schedule comprises fee structures that vary as a function of time; fees that vary as a function of system usage; fees that vary as a function of the geographic location of a student client; fees that vary as a function of access bandwidth; fees that vary as a function of delivery medium; fees that vary as a function of a student client's affiliation with an academic institution or other entity; or fees that vary as a function of the course in which a student client is enrolled.

51. The system of claim 46 wherein said monitoring records in a database each student client's usage of each form of content and the amount of time that the student has used the content.

52. The system of claim 46 wherein said monitoring records whether the student client was viewing multiple sources of content simultaneously.

53. The system of claim 46 wherein said monitoring is performed on a fee basis by a service provider.

54. The system of claim 45 wherein said appropriate payments are determined as a function of the recorded usage for each content source and determining the payment due based directly on a designated fee schedule.

55. The system of claim 45 wherein said appropriate payments are determined as a function of the recorded usage for each content source and the content source's designated fee schedule.

56. The system of claim 45 wherein said appropriate payments are determined as a function of the recorded usage for each content source based on determining the content source's relative contribution and fee schedule then allocating a fraction of total course revenue to each content source based on the content source's relative contribution.

57. The system of claim 45 wherein said appropriate payments are aggregated across the student client and content source.

58. The system of claim 45 wherein said appropriate payments are determined as a function of financial aid and content source utilization by the student client.

59. The system of claim 45 wherein said appropriate payments are determined as a function of scholarships or stipends and content source utilization by the student client.

60. The system of claim 45 wherein said appropriate payments are determined as a function of the net difference between payments to at least one content source.

61. The system of claim 45 wherein the educational content is provided over a communications network.

62. The system of claim 61 wherein said communications network comprises permanent connections, such as wire or fiber optic cables; temporary connections made through telephone connections; public and/or private wide area networks; local area networks; wireless networks, Bluetooth link, data communication networks or connections, intranets, internets, the Internet, routers, satellite links, microwave links, cellular or telephone networks, radio links, fiber optic transmission lines, ISDN lines, T1 lines, and DSL.

63. The system of claim 61 wherein the communications network includes at least one wireless link.

64. The system of claim 61 wherein the communications network includes at least one Bluetooth link.

65. The system of claim 45 wherein said recording the usage of educational content is performed on a fee basis by a service provider.

66. The system of claim 45 wherein said fee schedule is generated by a service provider.
